(19) United States
(12) Patent Application Publication
(10) Pub. No.: US 2016/0365727 A1
(43) Pub. Date: Dec. 15, 2016

(54) System For Cancelling Fundamental Neutral Current On A Multi-Phase Power Distribution Grid

(71) Applicant: Gridco, Inc., Woburn, MA (US)

(72) Inventors: Anthony Kam, Arlington, MA (US); James Simonelli, Grafton, MA (US)

(73) Assignee: Gridco, Inc.

(21) Appl. No.: 15/178,943

(22) Filed: Jun. 10, 2016

Related U.S. Application Data
(60) Provisional application No. 62/173,522, filed on Jun. 10, 2015.

(51) Int. Cl. H02J 3/01; H02H 7/28

(52) U.S. Cl. CPC H02J 3/01; H02H 7/28

(57) ABSTRACT

A system for cancelling fundamental neutral current on a multi-phase power distribution grid. The system includes a controller coupled to the power distribution grid responsive to a neutral current signal configured to determine a first corrective current based on at least the neutral current signal. A power module responsive to the controller is configured to generate the first corrective current. A transformer subsystem includes primary windings coupled to the power distribution grid and a zero sequence voltage point coupled to the power module. The transformer subsystem is configured to transform the first corrective current into a second corrective current coupled to the power distribution grid such that the second corrective current cancels all or part of a fundamental neutral current. The power module is configured as a four-quadrant power module which provides real power flow in either direction between the power module and the transformer subsystem at the zero sequence voltage point.

### RELATED APPLICATIONS

This application claims benefit of and priority to U.S. Provisional Application Ser. No. 62/173,522 filed Jun. 10, 2015, under 35 U.S.C. §§119, 120, 363, 365, and 37 C.F.R. §1.55 and §1.78, which is incorporated herein by this reference.

### FIELD OF THE INVENTION

This invention relates to a system for cancelling fundamental neutral current on a multi-phase power distribution grid.

### BACKGROUND OF THE INVENTION

Multi-phase power distribution systems, such as a low or medium or high voltage three-phase power distribution grid, are often discussed in terms of being a “balanced” system or an “unbalanced” system. A system which is “balanced” has positive attributes both in its ability to be simply analyzed and in its physical characteristics. Conversely, an “unbalanced” system may be more difficult to analyze and may produce detrimental physical characteristics.

One problem associated with an unbalanced multi-phase system is that current will flow in the neutral conductor (if present). The amount of current flowing in the neutral conductor is equal to the sum of the currents flowing in each of the phase conductors. Unless specified otherwise, as used herein, “sum” refers to vector sum/complex sum/phasor sum, as known by those skilled in the art. In a “balanced” multi-phase system, the sum of these currents is equal to zero. Current flowing in the neutral conductor (and additionally in a ground connection for multi-grounded neutral wiring systems) can be problematic for power systems. These problems may include, inter alia, false tripping of protection systems, the need to de-sensitize protection systems (which may lead to a safety risk), and/or and increasing losses and possibly increasing public safety risk by producing stray voltage.

One cause of a multi-phase system to become unbalanced is the load connections, e.g., in a three-phase system, every load may be capable of drawing current from either one, two, or all three phases. As used herein, “load” refers to any element or set of elements that draws current (of any phase angle) and includes elements that consume real power (e.g., heaters, household appliances, and the like), elements that generate real power (e.g., generators, photo-voltaic systems, and the like), and elements that consume/generate reactive power (e.g., capacitors, inductors, certain inverters, and the like). Loads that draw currents from one or two phases are typically referred to as “single phase” loads and loads that draw current from all three phases are called “three-phase” loads. If all loads were three-phase and were drawing equal current from each phase, the three-phase system would be balanced. However, in practice, many single phase loads exist, e.g., most residential homes, some commercial facilities and the like, and their associated loads. These single-phase loads act independently and typically draw different currents from the different phases, causing the multi-phase system to become unbalanced. Therefore, virtually every multi-phase system or power distribution grid is unbalanced. If the system contains a neutral conductor, there is a potential for the problems discussed above to be present.

The magnitude of the current flowing in the neutral conductor may vary based on the degree of unbalance. Typically, the larger the unbalance, the larger the variation between the phase currents, the greater the neutral current. Power system planners and engineers typically choose conductors and design protection circuits with an understanding of an “allowable” existence of unbalance. If load connections and patterns remain within the expected limits, then the power system will likely properly function. However, if load connections and patterns change (in both time and location) then a larger unbalance may occur leading to larger neutral current. These larger neutral currents may trip protection circuits causing power outages to loads/customers. Such outages put the power system engineer in a difficult position. On one hand, they do not want to disrupt power to loads/customers. On the other hand, they do not want to de-sensitize the protection settings to allow larger neutral currents, as the conductors and protection settings were designed with customer safety in mind. Faced with this challenge, power system engineers will often send linemen (or electricians in the case of buildings) to re-wire loads in an attempt to distribute them in a more balanced manner. Alternatively, the power engineers may also choose to “block” (ignore a trip command) during times where a high unbalance is anticipated. Both of these have cost and risk associated with them. As a last resort, the whole power system may need to be redesigned with different load connection and protection settings. Additionally, none of these solutions are feasible if unbalance occurs in a more dynamic nature which may be more possible for the broader scale deployment of larger (and varying size) single-phase loads/generators, such as residential electric vehicle chargers and photo-voltaic systems, both of which can cause unplanned unbalance on hourly timescales.

One conventional system to mitigate the impact of unbalanced currents in a multi-phase system, such as a three-phase, four wire power distribution grid, is to deploy a power device connected to the three phase conductors and the neutral conductor or wire. The power device is programmed to “shift” current between phases such that the current before/up-stream of the power device is more balanced than the down-stream current. An example of a conventional power device is a Static Compensator (STATCOM). The electrical rating of the internal power electronics of the STATCOM is proportional to the product of the amount of unbalanced current flowing in the neutral conductor and the system phase to neutral voltage. Such that:

S_{STATCOM}≅V_{L-N}*I_{N} (1)

where V_{L-N} is the line-to-neutral voltage (also known as phase-to-neutral voltage) and I_{N} is the neutral current.

For example, on a typical medium voltage three-phase, four wire power distribution grid, with 7,200 V_{L-N} and 20 amps of unbalanced current flowing in the neutral/ground connections, the three-phase STATCOM would need to be rated for at least approximately 144 kVA. Additionally, the electronic and electrical components which are used to construct the conventional STATCOM are generally capable of supporting voltages of less than 1,000 V. To connect a STATCOM to a 7,200 V_{L-N} system, a three-phase step-up transformer with a similar rating of 144 kVA may be used to couple the low(er) voltage STATCOM to the high(er) voltage distribution system. Size, cost and weight of power electronics systems scale with kVA rating. Although it is technically viable to use STATCOMs for dynamic phase balancing, the size, cost and weight of these systems have restricted their use for phase balancing purposes to primarily academic exercises. When STATCOMs are deployed, it is generally to provide other benefits to the power system, such as dynamic reactive current injection/absorption or in special cases, harmonic current cancellation, and the like. These additional benefits require a much higher rated device (e.g., about 1 MVA) and require the placement of the STATCOM in a more centralized and protected location. This increased size and location is another drawback to deploying STATCOMs for the sole use case of neutral current mitigation.

To overcome the problems associated with STATCOMs, several conventional “smaller” neutral current cancelling devices are known. These conventional devices typically have electrical ratings much smaller than a comparable STATCOM.

One such conventional neutral current cancelling device is disclosed in U.S. Pat. No. 5,568,371 incorporated by reference herein. The '371 patent discloses a neutral current cancelling device with a small electrical rating. However, device as disclosed therein can only be used to cancel harmonic neutral currents. Harmonic currents are electrical alternating currents (AC) having a frequency different than the nominal frequency of the power distribution network (in the U.S. 60 Hz). Harmonic currents are typically generated by non-linear loads and certain harmonic currents, notably triplens, may contribute significantly to the current in the neutral conductor resulting in the problems discussed above. However, the neutral current caused by unbalanced single-phase loads on a multi-phase power distribution grid discussed above is primarily fundamental, i.e. the neutral current is at the same frequency as the nominal frequency, referred to herein as fundamental neutral current. The device and method as taught in the '371 patent is not designed to cancel fundamental neutral current. In fact, the hardware of the device as disclosed in the '371 patent includes a rectifier which makes it incapable of cancelling arbitrary fundamental neutral current because it cannot support 4-quadrant operation.

Other conventional neutral current cancelling devices may also teach canceling only harmonic neutral current which also renders them incapable of mitigating problems caused by fundamental neutral current on a multi-phase power distribution grid.

U.S. Pat. No. 5,574,356, incorporated by reference herein, allegedly discloses a device which can cancel both harmonic and fundamental neutral current with an electrical rating which may be comparable to the '371 patent. However, the '356 patent assumes the zero sequence voltage in the power distribution grid is equal to zero at both fundamental and harmonic frequencies. As is well known in the art, the zero sequence voltage in a multi-phase power distribution grid is proportional to the sum of all the phase voltages, with a proportionality constant that depends on context and may involve transformer ratios, number of phases, and the like. As disclosed in the '356 patent, based on the assumption that the zero sequence voltage is zero, the active neutral current compensator consumes no real power (in the idealized sense) and needs to consume just enough real power to compensate loss (in practice). However, in actual power distribution grids, the zero sequence voltage is typically non-zero, particularly at the fundamental frequency. Moreover, the zero sequence voltage may not have any relation to the neutral current. As a result, a device that is able to cancel arbitrary fundamental neutral current (arbitrary magnitude and phase) in the presence of arbitrary zero sequence voltage (arbitrary magnitude and phase) needs to be able to support 4-quadrant operation. That is, such a device needs to allow arbitrary complex (real and reactive) power flow in all 4 quadrants, including but not limited to real power flow in either direction, at the zero sequence voltage point. The device as disclosed in the '356 patent will only operate correctly if the zero sequence voltage of the power distribution grid is zero. However, as discussed above, in actual power distribution grids, the zero sequence voltage is typically non-zero. As a result, the device as taught in the '356 patent may not be suitable for use in actual power distribution grids.

In summary, the conventional passive approach of re-wiring loads is not sustainable when load unbalance may occur hourly or daily. Conventional approach of blocking protections increases risk of customer shock/fire hazards. Conventional power devices such as STATCOMs have financial and size limitations. Circuit redesign has both financial limitations and implementation time delays. Devices such as disclosed in the '371 patent are designed to mitigate only harmonic neutral current caused by non-linear loads, and cannot mitigate fundamental neutral current caused by unbalanced single-phase loads. The device of the '356 patent is designed to mitigate both harmonic and fundamental neutral current but only if the zero sequence voltage is zero.

### SUMMARY OF THE INVENTION

In one aspect, a system for cancelling fundamental neutral current on a multi-phase power distribution grid is featured. The system includes a controller coupled to the power distribution grid responsive to a neutral current signal configured to determine a first corrective current based on at least the neutral current signal. A power module responsive to the controller is configured to generate the first corrective current. A transformer subsystem includes primary windings coupled to the power distribution grid and a zero sequence voltage point coupled to the power module. The transformer subsystem is configured to transform the first corrective current into a second corrective current coupled to the power distribution grid such that the second corrective current cancels all or part of a fundamental neutral current. The power module is configured as a four-quadrant power module which provides real power flow in either direction between the power module and the transformer subsystem at the zero sequence voltage point.

In one embodiment, the multi-phase power distribution grid may include a three-phase four wire distribution grid. The power module may include a first inverter coupled to the transformer subsystem at the zero sequence voltage point configured to generate the first corrective current. The power module may include a second inverter coupled to the transformer subsystem configured to exchange real power with the transformer subsystem to enable real power flow in either direction between the first inverter and the transformer subsystem at the zero sequence voltage point. The power module may include a second inverter coupled to the power distribution grid configured to exchange real power with the power distribution grid to enable real power flow in either direction between the first inverter and the transformer subsystem at the zero sequence voltage point. The transformer subsystem may include a wye-delta transformer with an open delta configured such that an opening in the delta windings provide the zero sequence voltage point. The transformer subsystem may include a wye-delta transformer with a closed delta configured such that the intersection of wye windings provide the zero sequence voltage point. The transformer subsystem may include a zig-zag transformer configured such that the intersection of windings provide the zero sequence voltage point. The transformer subsystem may include one or more single-phase transformers configured to provide the zero sequence voltage point. The one or more sensors may be configured to provide the neutral current signal. The one or more of the sensors may be configured to sense a neutral current of the power distribution grid. The one or more of the sensors may be configured to sense one or more phase currents of the power distribution grid. At least one of the sensors may be located on a load-side of a connection point where the transformer subsystem couples to the power distribution grid. At least one of the sensors may be located on a source-side of a connection point where the transformer subsystem couples to the power distribution grid. The controller may be configured to include at least filtering the neutral current signal and/or the first corrective current. The neutral current signal may be based on a current from a load-side of a connection point where the transformer subsystem couples to the power distribution grid. The neutral current signal may be based on a current from a source-side of a connection point where the transformer subsystem couples to the power distribution grid. The controller may be configured to determine the first corrective current by open loop control. The controller may be configured to determine the first corrective current by closed loop control. The controller maybe configured to determine whether the neutral current signal is based on a current from a load-side or a source-side of at least one connection point where the transformer subsystem is coupled to the power distribution grid. The controller maybe configured to use open loop control when the neutral current signal is based on a current from the load-side and use closed loop control when the neutral current signal is based on a current from the source-side. The controller may determine whether the neutral current signal is based on a current from the load side or the source-side based on at least a message received from an external device. The controller may determine whether the neutral current signal is based on a current from the source-side or the load-side based at least in part on comparing values of the neutral current signal at two different points in time. The controller may determine whether the neutral current signal is based on a current from the source-side or the load-side based at least in part on measuring the direction of power flow in the phase conductors. The system may include a fault detection module to determine if there is a fault in the power distribution network. The system may be configured to stop cancelling the neutral current when the fault detection module determines there is a fault in the power distribution network. The system may be configured to set the first corrective current and the second corrective current to zero when the fault detection module determines there is a fault in the power distribution network. The multi-phase power distribution grid may operate at a medium voltage.

In another aspect, a system for cancelling neutral current on a multi-phase power distribution grid is featured. The system includes a controller coupled to the power distribution grid responsive to a neutral current signal configured to determine a first corrective current based on at least the neutral current signal. A power module responsive to the controller is configured to generate the first corrective current. A transformer subsystem includes primary windings coupled to the power distribution grid and a zero sequence voltage point coupled to the power module. The transformer subsystem is configured to transform the first corrective current into a second corrective current coupled to the power distribution grid such that the second corrective current cancels all or part of the neutral current. The controller is configured to determine whether the neutral current signal is based on a current from a load-side or a source-side of a connection point where the transformer subsystem is coupled to the power distribution network.

In yet another aspect, a system for cancelling fundamental neutral current on a multi-phase power distribution grid is featured. A controller coupled to the power distribution grid responsive to a neutral current signal is configured to determine a first corrective current based on at least the neutral current signal. A power module including at least a first inverter and second inverter responsive to the controller is configured to generate the first corrective current. A transformer subsystem includes primary windings coupled to the power distribution grid and a zero sequence voltage point coupled to the power module. The transformer subsystem is configured to transform the first corrective current into a second corrective current coupled to the power distribution grid such that the second corrective current cancels all or part of the neutral current. The power module is configured as a four-quadrant power module which provides real power flow in either direction between the power module and the transformer subsystem at the zero sequence voltage point.

The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a circuit diagram of a conventional power device which may be used to cancel or mitigate neutral current on a multi-phase power distribution grid;

FIG. 2 is a schematic block diagram showing the primary components of one embodiment of a system for cancelling fundamental neutral current on a multi-phase power distribution grid of this invention;

FIG. 3 is a schematic block diagram showing the primary components of another embodiment of a system for cancelling fundamental neutral current on a multi-phase power distribution grid of this invention;

FIG. 4 is a schematic block diagram showing the primary components of another embodiment of a system for cancelling fundamental neutral current on a multi-phase power distribution grid of this invention;

FIG. 5 is a schematic block diagram showing the primary components of another embodiment of a system for cancelling fundamental neutral current on a multi-phase power distribution grid of this invention;

FIG. 6 is a schematic block diagram showing the primary components of one embodiment of one or more filters which may be employed by the controller shown in one or more of FIGS. 2-5; and

FIG. 7 is a flow chart showing one example of the primary functions of the various components of the system shown in one or more of FIGS. 2-6.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

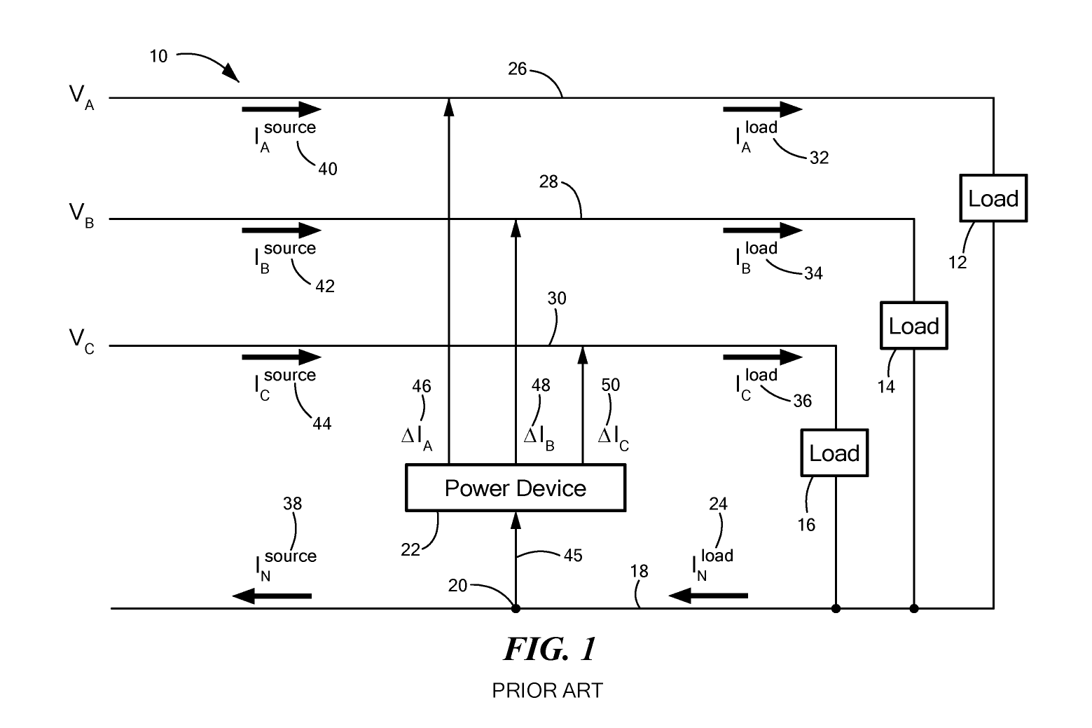

As discussed in the Background section above, multi-phase power distribution grid 10, FIG. 1, in this example, a three-phase, four wire power distribution grid, may become unbalanced due to load connections, e.g., at loads 12, 14, and 16. In this example, the loads 12, 14 and 16 are all single-phase loads and connect to phase conductors 26, 28, and 30. If all loads 12-16 were drawing equal current from each phase, power distribution grid 10 would be balanced. However, in practice, at any given moment in time, the different loads 12-16 (e.g., different residential homes or similar loads as discussed in the Background section above) would typically draw different currents which causes power distribution grid 10 to become unbalanced. The unbalance due to loads 12-16 results in a fundamental neutral current flow in neutral conductor 18 due to the unbalance. In this example, the fundamental neutral current flowing in neutral conductor 18 is on the “load-side” of connection point 20 where power device 22 is coupled to grid 10 and is referred to herein as I_{N}^{load}-24. In this example, I_{N}^{load}-24 is equal to the sum of currents flowing in each phase conductor wires 26, 28, and 30, I_{A}^{load}-32, I_{B}^{load}-34, and I_{C}^{load}-36, respectively. If the fundamental neutral current flowing I_{N}^{load}-24 flows to the source-side of connection point 20 as I_{N}^{source}-38 it may be injected back into power distribution grid 10 resulting in the problems discussed in the Background Section above.

Conventional power device 22, e.g., a STATCOM, coupled to phase conductors 26, 28, and 30 and neutral conductor 18 may be used to cancel all or part of fundamental neutral current I_{N}^{source}-38 to mitigate the problems associated with current in neutral conductor 18. Conventional power device 22 is typically programmed to shift current between phases by injecting currents ΔI_{A}-46, ΔI_{B}-48, and/or ΔI_{C}-50 into phase conductors 26, 28, and/or 30, and removing current at connection point 20 coupled to neutral conductor 18, indicated at 45, to cancel or reduce fundamental neutral current I_{N}^{source}-38 and to cause the phase currents upstream or on the source-side, e.g., I_{A}^{source}-40, I_{B}^{source}-42 and I_{C}^{source}-44 to be more balanced than the downstream or load-side phase currents, e.g., I_{A}^{load}-32, I_{B}^{load}-34, and/or I_{C}^{load}-36.

However, although it is technically viable to use a STATCOM to cancel fundamental neutral current I_{N}^{source}-38 the large rating, size, cost and weight of a STATCOM may restrict its use for phase balancing purposes as primarily an academic exercise. When a STATCOM is deployed as power device 22, it is typically to provide other benefits to the power system, such as dynamic reactive current injection/absorption or in special cases, harmonic current cancellation, and the like. These additional benefits require a much higher rated device and require the placement of the STATCOM in a more centralized and protected location. This increased size and placement challenge is another problem associated with power device 22 for use in fundamental neutral current mitigation.

Another conventional power device 22 for cancelling neutral currents is disclosed in the '371 patent discussed in the Background section above. As discussed above, the device and method as taught in the '371 patent is specifically designed to cancel harmonic neutral current and is not designed to cancel fundamental neutral current. The hardware of the device as disclosed in the '371 patent includes a rectifier which makes it incapable of cancelling arbitrary fundamental neutral current because it cannot support 4-quadrant operation.

Yet another conventional power device 22 for cancelling neutral currents is disclosed in the '356 patent discussed in the Background section. However, the device as disclosed in the '356 patent will only operate correctly if the zero sequence voltage of the power distribution grid is zero. However, as discussed above, in actual power distribution grids, the zero sequence voltage is typically non-zero. As a result, the device as taught in the '356 patent is not suitable for use in actual power distribution grids, such as power distribution grid 10.

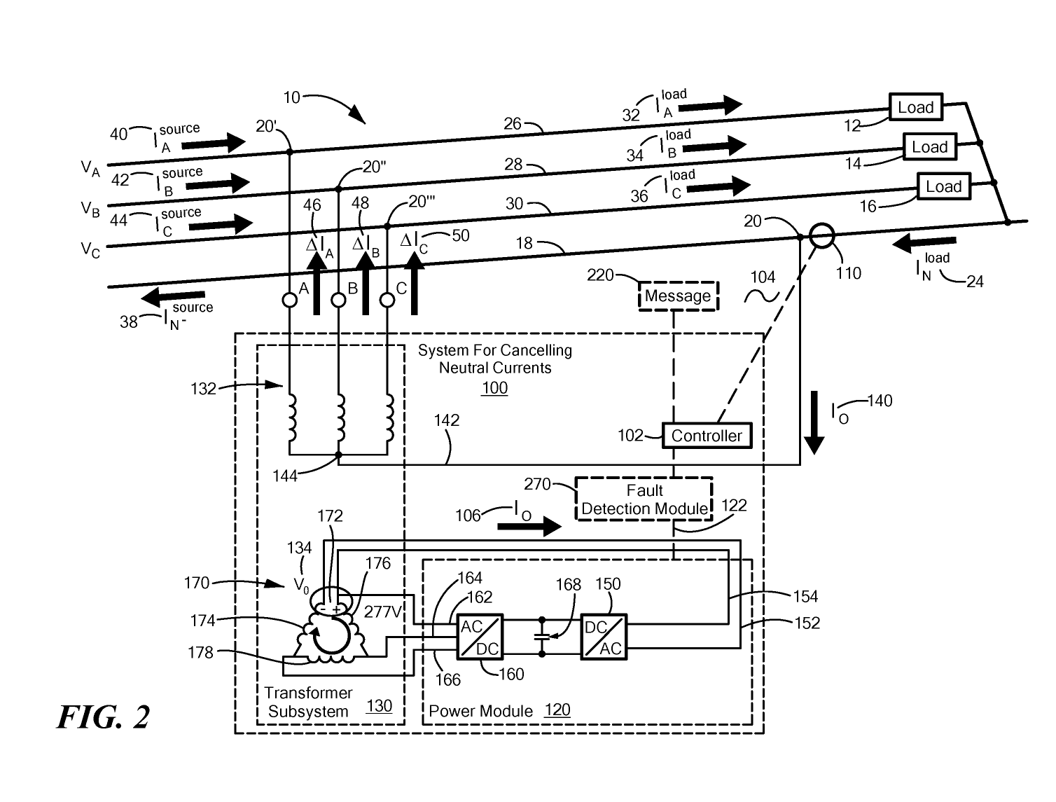

There is shown in FIG. 2, where like parts have been given like numbers, one embodiment of system 100 for cancelling all or part of fundamental neutral current I_{N}^{source}-38 on multi-phase power distribution grid 10. In one example, multi-phase power distribution grid 10 may be three-phase, four wire power distribution grid 10 as shown. In other examples, multi-phase power distribution grid 10 may be a two-phase, three conductor power distribution grid. Regardless of number of phases and number of conductors, multi-phase power distribution grid 10 may operate at medium, low or high voltage.

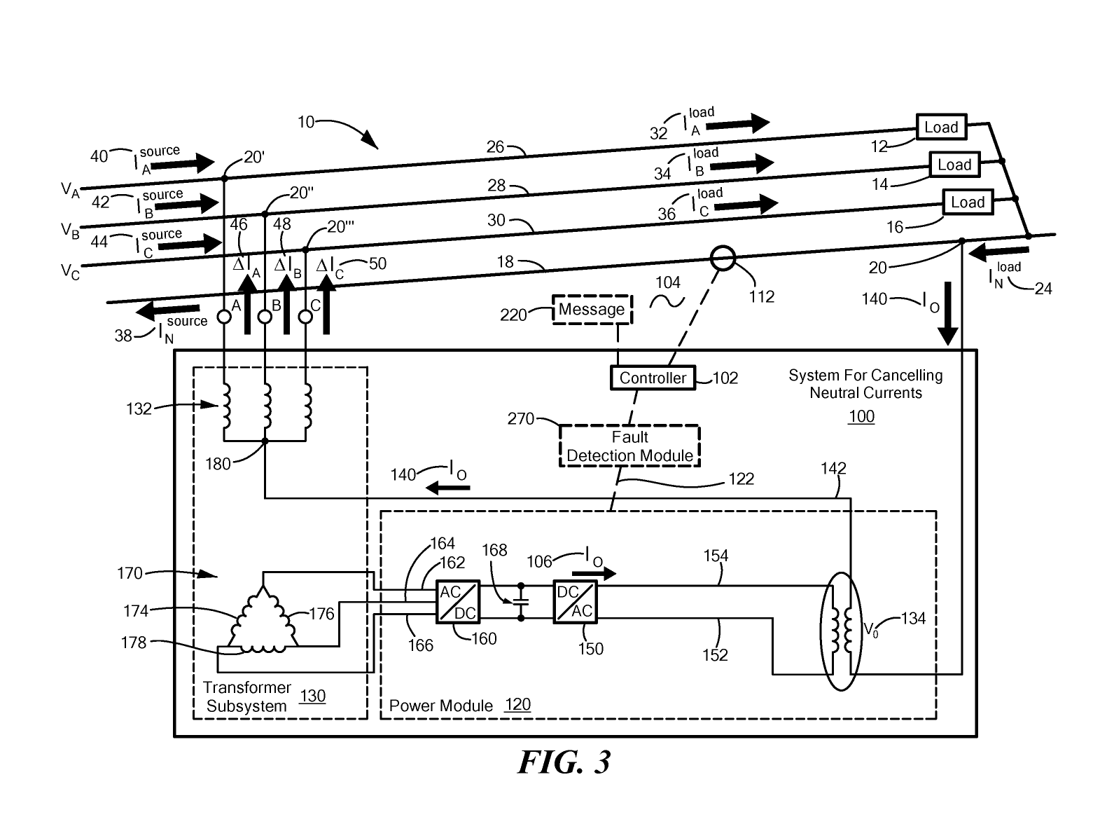

System 100 includes controller 102 coupled to multi-phase power distribution grid 10 responsive to a neutral current signal or signals, referred to herein as neutral current signal 104. Controller 102 is configured to determine a first corrective current, I_{O}-106, based on at least neutral current signal 104. In the example shown in FIG. 2, neutral current signal 104 may be provided from one or more sensors, e.g., sensor 110, coupled to neutral conductor 18 and located on the load-side of connection point 20. In other examples, as shown in FIGS. 3-5, where like parts have been given like numbers, discussed in detail below, neutral current signal 104 may be provided from at least one sensor on the source-side of connection point 20 coupled to neutral conductor 18, or on the source-side or load-side of connection points 20′, 20″, and/or 20′″ coupled to one or more of phase conductors 26, 28, and/or 30.

System 100 also includes power module 120 operatively responsive to controller 102, indicated at 122, configured to generate first corrective current I_{O}-106.

System 100 also includes transformer subsystem 130 which includes primary windings 132 coupled to power distribution grid 10 and zero sequence voltage point, V_{O}-134, coupled to power module 120 by lines 152 and 154, as shown. The first corrective current O_{O}-106 generated by power module 120 is coupled to the zero sequence voltage point, V_{O}-134, in this example by lines 152 and 154. Transformer subsystem 130 is configured to transform first corrective current I_{O}-106 into second corrective current I_{O}-140 coupled to power distribution grid 10 such that second corrective current I_{O}-140 cancels all or part of the fundamental neutral current I_{N}^{source}-38. In the example shown in FIG. 2, first corrective current I_{O}-106 is transformed to second corrective current I_{O}-140 and second corrective current I_{O}-140 is removed from neutral conductor 18 at connection point 20 to cancel all or part of fundamental neutral current I_{N}^{source}-38. Second corrective current I_{O}-140 is also evenly divided at point 144 to windings 132 and injected into phase conductors 26, 28, and 30 of power distribution grid 10 as ΔI_{A}-46, ΔI_{B}-48, ΔI_{C}-50, respectively. Although in this example second corrective current I_{O}-140 is removed from neutral conductor 18 at connection point 20 and injected into phase conductors 26-30 as shown, in other examples, second corrective current I_{O}-140 may be injected into neutral conductor 18 at connection point 20 to cancel all of part of fundamental neutral current I_{N}^{source}-38 and removed from phase conductors 26-30, depending on the direction of the arrow for second corrective current I_{O}-140, as is well known in the art.

As is well known in the art, because the first corrective current I_{O}-106 is coupled to the zero sequence voltage point V_{O}-134, the complex power flow at zero sequence voltage point V_{O}-134 equals the product of the zero sequence voltage and the complex conjugate of the first corrective current I_{O}-106. In an actual working power distribution grid 10, load-side neutral current I_{N}^{load}-24 may have arbitrary phase and consequently the first and second corrective currents, I_{O}-106, I_{O}-140, needed for neutral current cancellation also have arbitrary phase. Moreover, the zero sequence voltage is typically non-zero and can also have arbitrary phase. Therefore, the complex power flow at zero sequence voltage point V_{O}-134 also has arbitrary phase and can be in any of the four quadrants of the complex plane. Therefore, power module 120 of system 100 is preferably configured as a four-quadrant power module as shown to provide arbitrary complex power flow in all four quadrants, including real power flow in either direction, between power module 120 and transformer subsystem 130 at the zero sequence voltage point V_{O}-134. Also, the electrical rating of power module 120 is proportional to the absolute value of the complex power flow and therefore proportional to the zero sequence voltage. Since the zero sequence voltage is typically a very small fraction (typically less than 10%) of the line-to-neutral voltage, the electrical rating of the power module 120 may be much smaller than that of a conventional STATCOM.

As discussed above, in the example shown in FIG. 2, neutral current signal 104 is based on a neutral current from load-side of connection point 20 where transformer subsystem 130 couples to power distribution grid 10. As will be discussed in further detail below with respect to FIGS. 3-5, neutral current signal 104 may also be based on a neutral current from a source-side of connection point 20 or based on one or more phase currents from either source-side or load-side of connection points 20′, 20″, and/or 20′″, and first corrective current I_{O}-106 and second corrective current I_{O}-140 are determined and generated differently, yet the second corrective current I_{O}-140 will similarly cancel all or part of fundamental neutral current I_{N}^{source}-38.

Power module 120, FIGS. 2-5, preferably includes first inverter 150 coupled to transformer subsystem 130 at zero sequence voltage point V_{O}-134 by lines 152 and 154 as shown to generate first corrective current I_{O}-106.

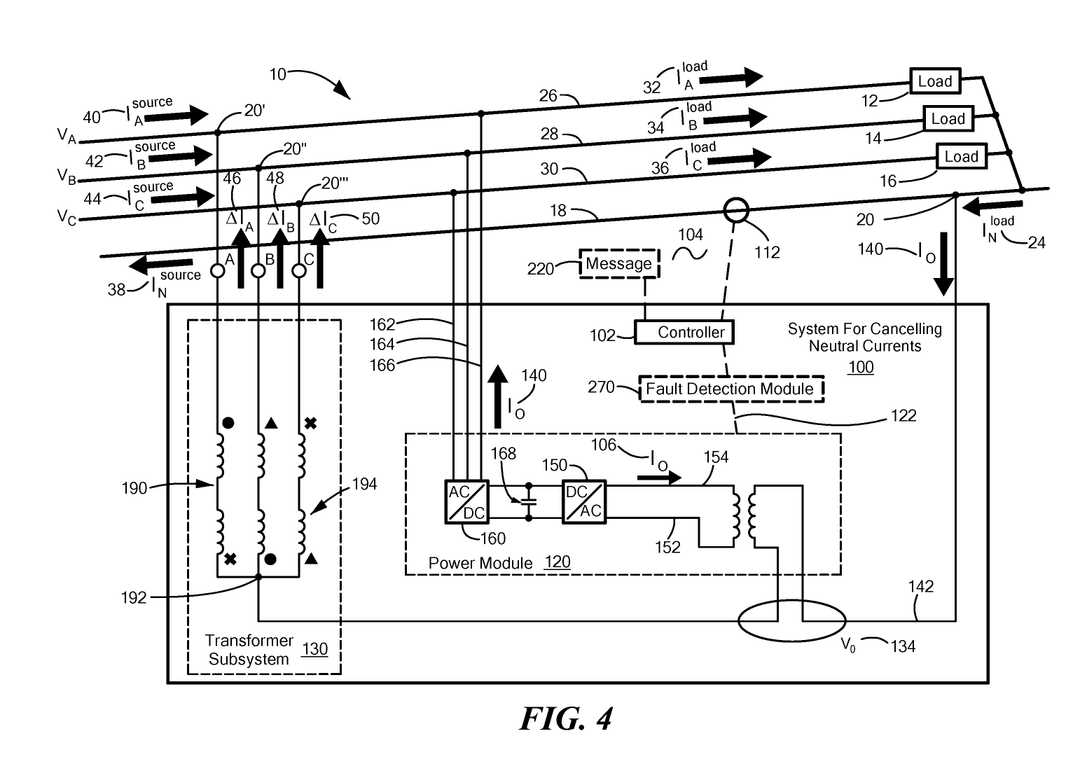

Power module 120, FIGS. 2, 3, and 5, also preferably includes second inverter 160 coupled to transformer subsystem 130 by lines 162, 164, and 166. As discussed above, the complex power flow at the zero sequence voltage point V_{O}-134 depends on the (typically non-zero) zero sequence voltage and the neutral current and may have arbitrary phase and in particular may include real power flow in either direction. Power module 120 as a whole may not source nor sink real power, except for operating loss. In the embodiment shown in FIGS. 2, 3, and 5, second inverter 160 exchanges real power with transformer subsystem 130 in order to enable the necessary real power flow in either direction between first inverter 150 and transformer subsystem 130 at zero sequence voltage point, V_{O}-134. That is, second inverter 160 exchanges real power with the transformer subsystem 130 in such a way that power module 120 as a whole does not source or sink real power, except for operating loss. In other designs, second inverter 160, FIG. 4, where like parts have been given like numbers, may be coupled to power distribution grid 10 by lines 162, 164, and 166 as shown and configured to exchange real power with the power distribution grid 10 in order to enable real power flow in either direction between first inverter 150 and transformer subsystem 130 at zero sequence voltage point V_{O}-134. In both examples, even though three lines 162, 164, 166 are shown, it is well known in the art there may be fewer or more lines between the second inverter 160 and transformer subsystem 130 or power distribution grid 10.

Power module 120, FIGS. 2-5, preferably includes DC bus 168 with one or more capacitors as shown between the first inverter 150 and second inverter 160 to facilitate the net real power exchange.

The result is system 100 provides a minimal weight, small, dynamic, cost effective actual working system which effectively and efficiently cancels all of part of fundamental neutral current on a multi-phase power distribution grid to mitigate the problems discussed in the Background section above. System 100 also has much smaller electrical rating, size, weight, and much lower cost when compared to a STATCOM or similar type power device. System 100 also includes a zero sequence voltage point and employs a four-quadrant power module which provides arbitrary complex power flow, including real power flow in either direction, between the power module and transformer subsystem at the zero sequence voltage point thereby enabling cancellation of arbitrary fundamental neutral current in the presence of arbitrary (typically non-zero) zero sequence voltage.

Transformer subsystem 130, FIGS. 2-5, preferably steps down medium (or high) voltage on power distribution grid 10 to a lower voltage for power module 120. In one example the medium voltage of power distribution grid 10 may be about 7.2 kV line-to-neutral voltage and the voltage provided to power module 120 may be about 277 V. In other examples, the medium (or high) voltage of power distribution grid 10 and the voltage provided to power module 120 may be higher or lower, as known by those skilled in the art.

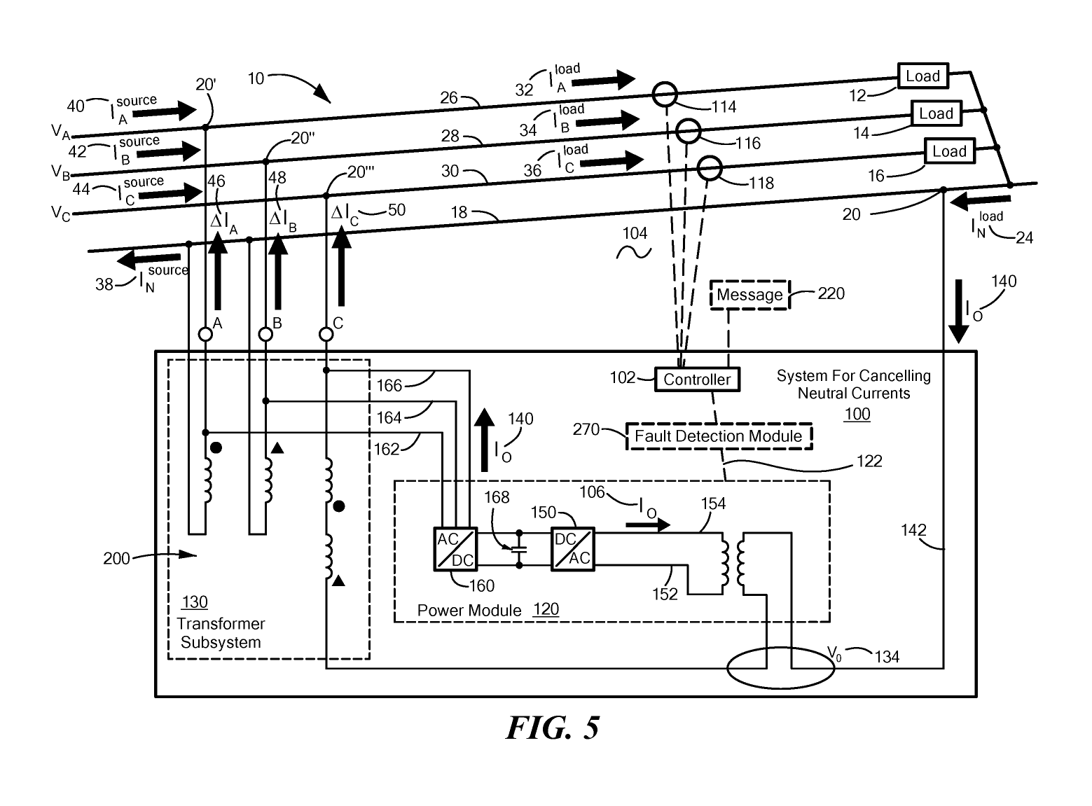

In one example, transformer subsystem 130, FIG. 2, may include wye-delta transformer 170 including an open delta configuration as shown such that opening 172 in delta windings 174, 176, 178 provides the zero sequence voltage point V_{O}-134. In another example, transformer subsystem 130, FIG. 3, may include wye-delta transformer 170 having a closed wye-delta as shown configured such that intersection 180 of wye windings 132 provides zero sequence voltage point V_{O}-134 as shown. In another example, transformer subsystem 130, FIG. 4, where like parts have been given like numbers, may include zig-zag transformer 190 configured such that intersection 192 of windings 194 provides zero sequence voltage point V_{O}-134 as shown. In another design, transformer subsystem 130, FIG. 5, may include one or more single-phase transformers 200 as shown configured to provide zero sequence voltage point V_{O}-134 as shown. In the example shown in FIG. 5, the one or more single-phase transformers 200 provide the zero sequence voltage point V_{O}-134 for a three-phase, four conductor power distribution grid 10. In other designs, one or more single-phase transformers 200 may be configured to provide the zero sequence voltage point for a two-phase, three conductor power distribution grid, as known by those skilled in the art.

As discussed above, system 100 preferably includes one or more sensors configured to provide neutral current signal 104. As defined herein, neutral current signal 104 may include one or more neutral currents, e.g., in a neutral conductor 18, FIGS. 2, 3, 4 or one or more phase currents, e.g., in one or more of phase conductors 26, 28, and 30, FIG. 5. As is well known in the art, the neutral current can be calculated as the sum of all the phase currents, thereby enabling the use of phase currents as the neutral current signal. In the example shown in FIG. 2, the one or more sensors include sensor 110, e.g., a current transformer (CT) sensor or similar type device, coupled to neutral conductor 18 on the load-side of connection point 20 where transformer subsystem 130 couples to power distribution grid 10 which senses neutral current in neutral conductor 18. In another example, the one or more sensors may include sensor 112, FIGS. 3 and 4, e.g., a current transformer (CT) sensor, coupled to neutral conductor 18 on the source-side of connection point 20 which senses the neutral current in conductor 18. In yet another design, the one or more sensors may include sensors 114, 116, and 118, FIG. 5, e.g., current transformer (CT) sensors, coupled to phase conductors 26, 28, and 30 which sense the phase current in phase conductors 26, 28, and 30, respectively. In the example shown in FIG. 5, the sensors 114, 116, 118 are located on the load-side of the connection points 20′, 20″, and/or 20′″ where transformer subsystem 130 couples to the phase conductors 26, 28, 30, but as is well known in the art, sensors 114-118 may also be on the source-side of connection points 20′, 20″, and/or 20′″. In other words, a sensor may be on neutral conductor 18 or one or more of phase conductors 26-30. Regardless of whether the sensor is on a neutral or phase conductor, the sensor (and the current it is sensing) may be on the load-side or the source-side, depending on its position relative to a connection point 20, 20′, 20″, 20′″ where the transformer subsystem 130 couples to that conductor. Sensors 110, 112, 114, 116, and 118, FIGS. 2-5 may or may not be considered part of system 100. For example, sensors 110, 112, 114, 116, and 118, may be external to system 100 and their measurements may even be shared with other equipment which may not be related to system 100.

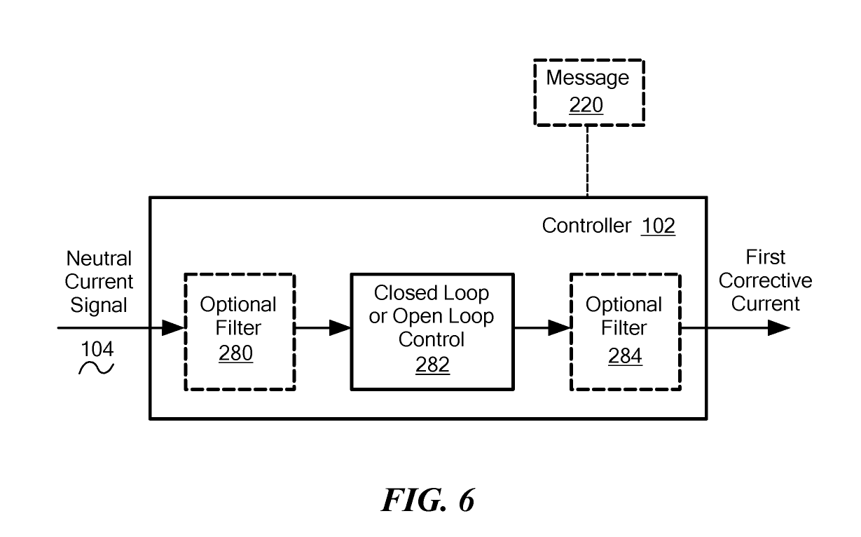

Controller 102, FIGS. 2-5, may be configured to include at least filtering of neutral current signal 104 and/or first corrective current I_{O}-106, e.g., with optional filter 280, FIG. 6 and/or optional filter 284. As is well known by those skilled in the art, such filters may include, e.g., a low-pass filter, time-averaging, smoothing, fixed delay, exponential delay, capping, and the like.

Controller 102, FIGS. 2-6, is preferably configured to determine whether neutral current signal 104 is based on current from a load-side or a source-side of connection point 20 on neutral conductor 18 or at least one of connection points, 20′, 20″ and/or 20′″ on phase conductors 26, 28 and/or 30. In one design, controller 102 may determine whether the neutral current signal 104 is based on current from the load-side or the source-side of connection point 20 or at least one of points 20′, 20″ and/or 20′″ based on message 220 from an external device. In another design, controller 102 may determine whether neutral current signal 104 is based on current from the source-side or the load-side of connection point 20 or connection points 20′, 20″ and/or 20′″ by comparing values of neutral current signal 104 at two different points in time. In yet another design, controller 102 may determine whether neutral current signal 104 is based on current from the source-side or the load-side of connection point 20 or at least one of connection points 20, 20′, 20″ and/or 20′″ by measuring the direction of real power flow in the phase conductors 26, 28, and/or 30. In the example shown in FIG. 2, controller 102 is configured to determine neutral current signal 104 is based on current in neutral conductor 18 from the load-side of connection point 20 using message 220 or by comparing values of neutral current signal 104 at two different points in time. In the example shown in FIGS. 3 and 4, controller 102 is configured to determine neutral current signal 104 is based on current in neutral conductor 18 from the source-side of connection point 20 using message 220 or by comparing values of neutral current signal 104 at two different points in time. In the example shown in FIG. 5, controller 102 is configured to determine neutral current signal 104 is based on current from the load-side of connection point or connection points 20′, 20″, 20′″ by using message 220 or by comparing values of neutral current signal 104 at two different points in time or by measuring the direction of power flow in the phase conductors 26, 28, and 30.

Once controller 102, FIGS. 2-6, has determined whether neutral current signal 104 is based on current from the source-side or the load-side of connection point 20 or connection points 20′, 20″ and/or 20′″, power module 120 generates the first corrective current I_{O}-106 and transformer subsystem 130 transforms first corrective current I_{O}-106 into second corrective current I_{O}-140 coupled to power distribution grid 10 such that second corrective current I_{O}-140 cancels all or part of the fundamental neutral current I_{N}^{source}-38. As discussed above, in the example shown in FIG. 2 and FIG. 5, neutral current signal 104 is based on current from load-side of connection point 20 and connection points 20′, 20″and/or 20′″. In the examples shown in FIGS. 3-4, neutral current signal 104 is based on current from source-side of connection point 20. In these examples, first corrective current I_{O}-106 is generated by first inverter 150 on lines 152 and 154 as shown and transformer subsystem 130 transforms first corrective current I_{O}-106 into second corrective current I_{O}-140 which is similarly removed from neutral conductor 18 at connection point 20 by line 142 to cancel all or part of fundamental neutral current I_{N}^{source}-38. In these examples, second corrective current I_{O}-140 is similarly injected into phase wires 26, 28, and 30 of power distribution grid 10 as ΔI_{A}-46, ΔI_{A}-48, ΔI_{A}-50, respective as shown. Similar as discussed above, second corrective current I_{O}-140 may be injected into neutral conductor 18 at connection point 20 to cancel all of part of fundamental neutral current I_{N}^{source}-38 and removed from phase conductors 26-30.

Controller 102, FIGS. 2-6, may be configured to determine first corrective current I_{O}-106 using open loop control or closed loop control, e.g., as shown at 282, FIG. 6. As discussed above, the neutral current being minimized or cancelled is on the source-side, shown as I_{N}^{source}-38. As also discussed above, controller 102 determines if neutral current signal 104 is based on current on the source-side or the load-side of connection point 20 or connection points 20′, 20″ and/or 20′″. Based on the result, controller 102 perform one type of calculation when the neutral current signal 104 is based on current on the load-side and another type of calculation when the neutral current signal 104 is based on current from the source-side. If neutral current signal 104 is based on current on the source-side, e.g., as shown in FIGS. 3-4, then controller 102 has to determine first corrective current I_{O}-106 such that neutral current signal 104 value (e.g., either based on measured neutral current or based on summing measured phase currents) will be minimized. This is a classic example of “Closed Loop” control, where the signal (input to controller 102) is an error signal to be minimized, that is, controller 102 is given direct feedback on how it is performing and in an ideal final state the signal value will be zero. One example is shown in Table 1 below. The final first corrective current I_{O}-106 does not numerically equal the load-side neutral current because transformer subsystem 130 is utilized. There are many applicable closed-loop control schemes well known in the art, such as proportional/integral (PI) control, and the like.

TABLE 1
neutral current signal based on source-side current(s)

| | Source-side | Load-side | Neutral | First |
|---|---|---|---|---|
| | neutral | neutral | current | corrective |
| Time | current (Amp) | current (Amp) | signal (Amp) | current (Amp) |
| Initial | 20∠0 | 20∠0 | 20∠0 | 0 |
| Final | 0 | 20∠0 | 0 | 174∠0 |

Alternatively, if the neutral current signal 104 is based on current on the load-side, e.g., as shown in FIG. 2 and FIG. 5, then controller 102 needs to determine first corrective current I_{O}-106 such that, when first corrective current I_{O}-106 is transformed into a second corrective current I_{O}-140 and when the second corrective current I_{O}-140 is coupled to the distribution grid 10, the resulting source-side neutral current, I_{N}^{source}-38, will be minimized. It should be understood that the signal input to controller 102 is not an error signal to be minimized. Indeed, there is no direct measurement of any source-side current including source-side neutral current, which is the quantity to be minimized. In an ideal final state the signal value will not be zero, but rather, the (unmeasured) source-side neutral current will be zero. This is analogous to a form of “Open Loop” control, where there is no direct feedback on how controller 102 is performing. One example is shown in Table 2 below. Note that the final first corrective current I_{O}-106 does not numerically equal the load-side neutral current because the transformer subsystem 130 is utilized. In such “Open Loop” control, controller 102 needs to calculate the first corrective current I_{O}-106 and its expected effect on the unmeasured source-side neutral current, preferably based mainly on a model of transformer subsystem 130 and its coupling to the power distribution grid 10 and without the benefit of feedback. Such calculations may include e.g., resealing based on transformer ratios, number of phases, and simple addition/subtraction based on the exact topology of coupling.

TABLE 2
neutral current signal based on load-side current(s)

| | Source-side | Load-side | Neutral | First |
|---|---|---|---|---|
| | neutral | neutral | current | corrective |
| Time | current (Amp) | current (Amp) | signal (Amp) | current (Amp) |
| Initial | 20∠0 | 20∠0 | 20∠0 | 0 |
| Final | 0 | 20∠0 | 20∠0 | 174∠0 |

As shown above, the behavior of controller 102 needs to depend on whether the neutral current signal 104 is based on current on the source-side or the load-side. In some power distribution grids, reconfigurations may occur, e.g., due to a major fault or similarly type event and such reconfigurations may further lead to the reversal of the source-side and the load-side. Thus, the one or more sensors discussed above with reference to FIGS. 2-5 that were measuring a load-side current may, after a reconfiguration, be measuring a source-side current, and vice versa. Therefore, in one embodiment, controller 102 can dynamically decide whether neutral current signal 104 is based on current from the source-side or the load-side. In this example, a controller 102 can therefore function correctly in power distribution grids where reconfigurations may occur, and controller 102 may be combined, with conventional devices, e.g., such as disclosed in the '356 patent and the '371 patent discussed supra to enable such conventional devices to also function correctly in power distribution grids where reconfigurations may occur.

In one design, system 100, FIGS. 2-5, may preferably include fault detection module 270 as shown configured to determine if there is a fault in power distribution grid 10. Fault detection module 270 may be processor, digital signal processor (DSP), or similar type device, with software or firmware therein or may be a hardware circuit as known by those skilled in the art. When fault detection module 270 determines there is a fault in power distribution grid 10, fault detection module 270 may be configured to enable the various components of system 100 to stop cancelling fundamental neutral current I_{N}^{source}-38 and/or set first corrective current I_{O}-106 and second corrective current O_{O}-140 to zero.

In one design, multi-phase power distribution grid 10 may operate at a medium voltage.

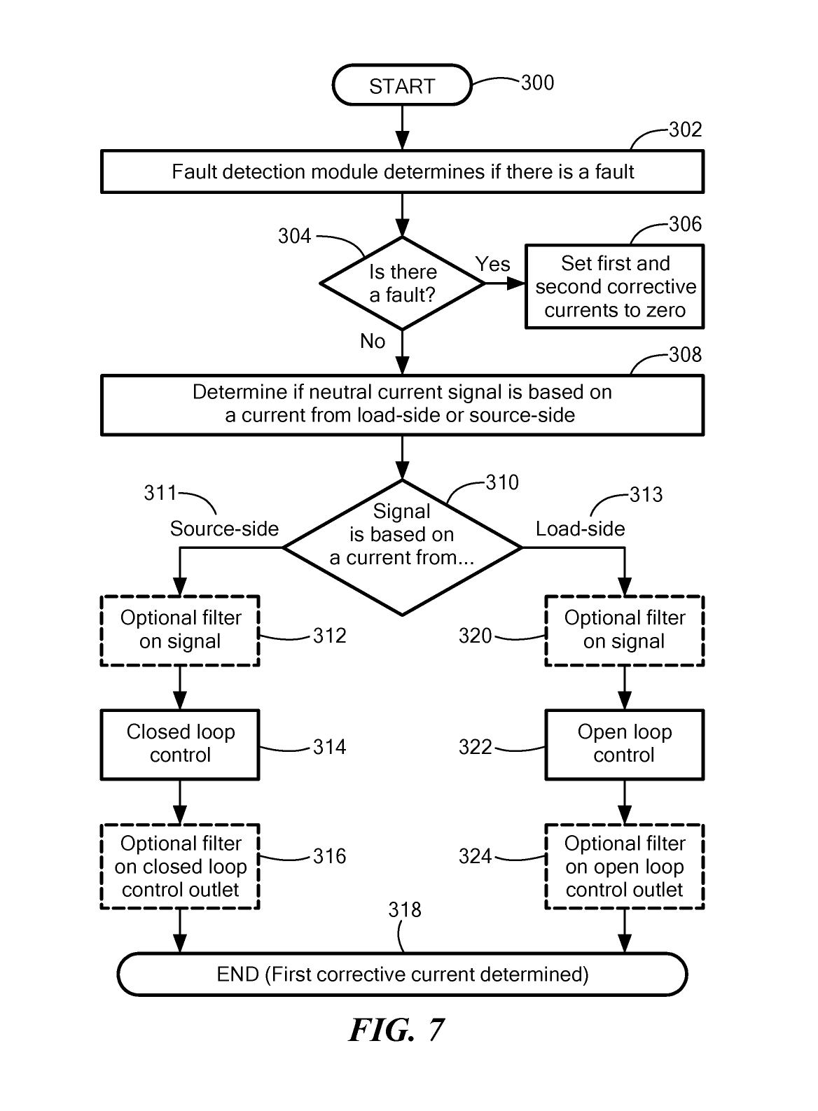

FIG. 7 shows a flowchart of one embodiment of an exemplary operation of system 100. In this example, system 100 is initialized, step 300. Fault detection module 270, FIGS. 2-5, determines if there is a fault, step 302. If there is a fault at step 304, controller 102 sets first corrective current I_{O}-106 and second corrective current I_{O}-140 to zero, step 306. If there is not a fault, controller 102 determines if neutral current signal 104 is based on current from a load-side or a source-side, step 308. In step 310, controller 102 takes different actions, steps 311 or step 313 based on the result of the determination in step 308. If neutral current signal 104 is based on a current from the source-side, indicated at step 311, optional filtering is performed on the signal, e.g., with filter 280, FIG. 6, step 312, FIG. 7, then closed loop control, step 314, and optional filter 284, FIG. 6, step 316, FIG. 7 are applied, to determine the first corrective current I_{O}-106, step 318. If the decision at 310 determines that neutral current signal 104 is based on current from a load-side, indicated at step 313, optional filtering is performed on the signal using filter 280, FIG. 6, step 320, FIG. 7, then open loop control, step 322, and optional filter 284, FIG. 6, step 324, FIG. 7, are applied to determine the first corrective current, step 318, FIG. 7.

One or more embodiments of the controller 102, power module 120 and/or fault detection module 270, FIGS. 2-6, of system 100 may include one or more processors, an ASIC, firmware, hardware, and/or software (including firmware, resident software, micro-code, and the like) or a combination of both hardware and software which may be part of or separate from controller 102, power module 120 and/or fault detection module 270.

Any combination of computer-readable media or memory may be utilized for controller 102, power module 120, and/or fault detection module 270. The computer-readable media or memory may be a computer-readable signal medium or a computer-readable storage medium. A computer-readable storage medium or memory may be, an electronic, magnetic, optical, electromagnetic, infrared, or semiconductor system, apparatus, or device, or any suitable combination of the foregoing. Other examples may include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. As disclosed herein, the computer-readable storage medium or memory may be any tangible medium that can contain, or store one or more programs for use by or in connection with one or more processors on a company device such as a computer, a tablet, a cell phone, a smart device, or similar type device.

Computer program code for the one or more programs for carrying out the instructions or operation of one or more embodiments of controller 102, power module 120, and/or fault detection module 270 may be written in any combination of one or more programming languages, including an object oriented programming language, e.g., C++, Smalltalk, Java, and the like, and conventional procedural programming languages, such as the “C” programming language or similar programming languages.

These computer program instructions may be provided to a processor of a general purpose computer, a controller, processor, or similar device included as part of controller 102, power module 120, and/or fault detection module 270, or separate from controller 102, power module 120, and/or fault detection module 270, or other programmable data processing apparatus to produce a machine, such that the instructions, which execute via the processor of the computer or other programmable data processing apparatus, create means for implementing the functions/acts specified in the flowchart and/or block diagram block or blocks.

The computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant cannot be expected to describe certain insubstantial substitutes for any claim element amended.

Other embodiments will occur to those skilled in the art and are within the following claims.

What is claimed is:

1. A system for cancelling fundamental neutral current on a multi-phase power distribution grid, the system comprising:
a controller coupled to the power distribution grid responsive to a neutral current signal configured to determine a first corrective current based on at least the neutral current signal;
a power module responsive to the controller configured to generate the first corrective current;
a transformer subsystem including primary windings coupled to the power distribution grid and a zero sequence voltage point coupled to the power module, the transformer subsystem configured to transform the first corrective current into a second corrective current coupled to the power distribution grid such that the second corrective current cancels all or part of a fundamental neutral current; and
wherein the power module is configured as a four-quadrant power module which provides real power flow in either direction between the power module and the transformer subsystem at the zero sequence voltage point.

2. The system of claim 1 in which the multi-phase power distribution grid includes a three-phase four wire distribution grid.

3. The system of claim 1 in which the power module includes a first inverter coupled to the transformer subsystem at the zero sequence voltage point configured to generate the first corrective current.

4. The system of claim 3 in which the power module includes a second inverter coupled to the transformer subsystem and configured to exchange real power with the transformer subsystem to enable real power flow in either direction between the first inverter and the transformer subsystem at the zero sequence voltage point.

5. The system of claim 3 in which the power module includes a second inverter coupled to the power distribution grid configured to exchange real power with the power distribution grid to enable real power flow in either direction between the first inverter and the transformer subsystem at the zero sequence voltage point.

6. The system of claim 1 in which the transformer subsystem includes a wye-delta transformer with an open delta configured such that an opening in the delta windings provide the zero sequence voltage point.

7. The system of claim 1 in which the transformer subsystem includes a wye-delta transformer with a closed delta configured such that the intersection of wye windings provide the zero sequence voltage point.

8. The system of claim 1 in which the transformer subsystem includes a zig-zag transformer configured such that the intersection of windings provide the zero sequence voltage point.

9. The system of claim 1 in which the transformer subsystem includes one or more single-phase transformers configured to provide the zero sequence voltage point.

10. The system of claim 1 further including one or more sensors configured to provide the neutral current signal.

11. The system of claim 10 in which one or more of the sensors are configured to sense a neutral current of the power distribution grid.

12. The system of claim 10 in which one or more of the sensors are configured to sense one or more phase currents of the power distribution grid.

13. The system of claim 10 in which at least one of the sensors are located on a load-side of a connection point where the transformer subsystem couples to the power distribution grid.

14. The system of claim 10 in which at least one of the sensors are located on a source-side of a connection point where the transformer subsystem couples to the power distribution grid.

15. The system of claim 1 in which the controller is configured to include at least filtering the neutral current signal and/or the first corrective current.

16. The system of claim 1 in which the neutral current signal is based on a current from a load-side of a connection point where the transformer subsystem couples to the power distribution grid.

17. The system of claim 1 in which the neutral current signal is based on a current from a source-side of a connection point where the transformer subsystem couples to the power distribution grid.

18. The system of claim 16 in which the controller is configured to determine the first corrective current by open loop control.

19. The system of claim 17 in which the controller is configured to determine the first corrective current by closed loop control.

20. The system of claim 1 in which the controller is configured to determine whether the neutral current signal is based on a current from a load-side or a source-side of at least one connection point where the transformer subsystem is coupled to the power distribution grid.

21. The system of claim 20 in which the controller is configured to use open loop control when the neutral current signal is based on a current from the load-side and use closed loop control when the neutral current signal is based on a current from the source-side.

22. The system of claim 20 in which the controller determines whether the neutral current signal is based on a current from the load side or the source-side based on at least a message received from an external device.

23. The system of claim 20 in which the controller determines whether the neutral current signal is based on a current from the source-side or the load-side based at least in part on comparing values of the neutral current signal at two different points in time.

24. The system of claim 20 in which the controller determines whether the neutral current signal is based on a current from the source-side or the load-side based at least in part on measuring the direction of power flow in the phase conductors.

25. The system of claim 1 further including a fault detection module to determine if there is a fault in the power distribution network.

26. The system of claim 25 in which the system is configured to stop cancelling the neutral current when the fault detection module determines there is a fault in the power distribution network.

27. The system of claim 25 in which the system is configured to set the first corrective current and the second corrective current to zero when the fault detection module determines there is a fault in the power distribution network.

28. The system of claim 1 in which the multi-phase power distribution grid operates at a medium voltage.

29. A system for cancelling neutral current on a multi-phase power distribution grid, the system comprising:
a controller coupled to the power distribution grid responsive to a neutral current signal configured to determine a first corrective current based on at least the neutral current signal;
a power module responsive to the controller configured to generate the first corrective current;
a transformer subsystem including primary windings coupled to the power distribution grid and a zero sequence voltage point coupled to the power module, the transformer subsystem configured to transform the first corrective current into a second corrective current coupled to the power distribution grid such that the second corrective current cancels all or part of the neutral current; and
wherein the controller is configured to determine whether the neutral current signal is based on a current from a load-side or a source-side of a connection point where the transformer subsystem is coupled to the power distribution network.

30. A system for cancelling fundamental neutral current on a multi-phase power distribution grid, the system comprising:
a controller coupled to the power distribution grid responsive to a neutral current signal configured to determine a first corrective current based on at least the neutral current signal;
a power module including at least a first inverter and second inverter responsive to the controller configured to generate the first corrective current;
a transformer subsystem including primary windings coupled to the power distribution grid and a zero sequence voltage point coupled to the power module, the transformer subsystem configured to transform the first corrective current into a second corrective current coupled to the power distribution grid such that the second corrective current cancels all or part of the neutral current; and
wherein the power module is configured as a four-quadrant power module which provides real power flow in either direction between the power module and the transformer subsystem at the zero sequence voltage point.
